(19) United States
(12) Patent Application Publication
(10) Pub. No.: US 2025/0189468 A1
(43) Pub. Date: Jun. 12, 2025

(54) Analysis System, Analysis Method, and Analysis Program

(71) Applicant: Hitachi High-Tech Corporation, Minato-ku, Tokyo (JP)

(72) Inventors: Keiichi TANAKA, Tokyo (JP); Akira TAKANO, Tokyo (JP); Hajime SHIMADA, Tokyo (JP); Muneyuki FUKUDA, Tokyo (JP)

(21) Appl. No.: 18/843,158

(22) PCT Filed: Mar. 18, 2022
(86) PCT No.: PCT/JP2022/012637

§ 371 Date: Aug. 30, 2024

(51) Int. Cl. G01N 23/2252; G01N 23/20091

(52) U.S. Cl. CPC G01N 23/2252; G01N 23/20091; G01N 2223/0563; G01N 2223/302; G01N 2223/305

(57) ABSTRACT

An object of the present disclosure is to obtain sufficient analysis accuracy and throughput when a sample is analyzed using two or more element analysis devices having different energy resolutions. An analysis system according to the present disclosure performs elemental analysis by using a second element analysis device having higher energy resolution than a first element analysis device, based on a result obtained by comparing a first energy spectrum of a target sample acquired by using the first element analysis device with a second energy spectrum of a reference sample acquired by using the first element analysis device (see FIG. 2).

### TECHNICAL FIELD

The present disclosure relates to an analysis system for analyzing an element contained in a sample.

### BACKGROUND ART

By combining an electron microscope and an element analysis device, it is possible to obtain information on element species, element distribution, and the like of a portion observed using the electron microscope. As the element analysis device, for example, an energy dispersive X-ray spectroscopy (EDS) device is used. As the electron microscope, for example, a scanning electron microscope (SEM) is used.

PTL 1 below discloses a technique of analyzing element distribution using EDS and further performing, by using a wavelength dispersive X-ray spectrometer (WDS), elemental analysis on each distribution region obtained as a result thereof.

NPL 1 below discloses an X-ray analyzer using a superconducting transition edge sensor (TES) having higher energy resolution than EDS.

### CITATION LIST

### Patent Literature

PTL 1: JP2019-012019A

### Non Patent Literature

[NPL 1] Keiichi Tanaka, Akira Takano, Atsushi Nagata, Satoshi Nakayama, Kaname Takahashi, Masahiko Ajima, Kenji Obara, Kazuo Chinone, “High sensitivity X-ray analysis for a low accelerating voltage scanning electron microscope using a transition edge sensor”, Microscopy, Volume 69, Issue 5, October 2020, Pages 298-303

### SUMMARY OF INVENTION

### Technical Problem

Compared with TES, the EDS has higher measurement throughput but lower energy resolution, and thus there is a possibility that an element cannot be sufficiently identified. Therefore, when the element cannot be sufficiently identified by using the EDS, it is conceivable to switch the measurement device to the TES to perform further analysis. However, since TES has high energy resolution but low throughput, there is a concern that the measurement throughput may decrease excessively when TES is excessively used.

In NPL 1, characteristics of the EDS and the TES are compared but the criteria for switching between both devices are not described. In PTL 1, an element distribution map is created using an EDS and then a WDS is used for each element phase, and it is not sufficiently considered to achieve both energy resolution and throughput between the EDS and the WDS.

The present disclosure has been made in view of the above problems, and an object thereof is to obtain sufficient analysis accuracy and throughput when a sample is analyzed using two or more element analysis devices having different energy resolutions

### Solution to Problem

An analysis system according to the present disclosure performs elemental analysis by using a second element analysis device having higher energy resolution than a first element analysis device, based on a result obtained by comparing a first energy spectrum of a target sample acquired by using the first element analysis device with a second energy spectrum of a reference sample acquired by using the first element analysis device.

### Advantageous Effects of Invention

According to the analysis system of the present disclosure, in a case of analyzing a sample using two or more types of element analysis devices having different energy resolution, it is possible to obtain sufficient analysis accuracy and throughput. Other problems, configurations, advantages, and the like of the present disclosure become apparent from the following description of embodiments.

### BRIEF DESCRIPTION OF DRAWINGS

FIG. 1 is a configuration diagram of an analysis system 1 according to Embodiment 1.

FIG. 2 is a flowchart illustrating an operation of the analysis system 1.

FIG. 3 illustrates an example of a first energy spectrum 31 and a second energy spectrum 32 in S203.

FIG. 4 is a graph illustrating another example of matching processing between energy spectrums.

FIG. 5 is a flowchart illustrating an operation of the analysis system 1 in a case of matching energy spectrum between a target portion 141 and a reference portion 142.

FIG. 6 illustrates an example in which an energy spectrum acquired using an EDS and an energy spectrum acquired using a TES are reflected together.

FIG. 7 is a flowchart illustrating an operation of the analysis system 1 according to Embodiment 2.

FIG. 8 is a side sectional view schematically illustrating an acceleration voltage of an electron beam 151 and the spread of the electron beam 151 in a sample 16.

FIG. 9 is a diagram illustrating an energy spectrum in a case where the target portion 141 is an organic substance and an energy spectrum in a case where the target portion 141 is an inorganic substance.

FIG. 10 is a flowchart illustrating an operation of the analysis system 1 according to Embodiment 3.

FIG. 11 is a flowchart illustrating an operation of the analysis system 1 according to Embodiment 4.

FIG. 12 illustrates an example of a user interface provided by a computer system 13.

FIG. 13 illustrates another example of the user interface provided by the computer system 13.

### DESCRIPTION OF EMBODIMENTS

### Embodiment 1

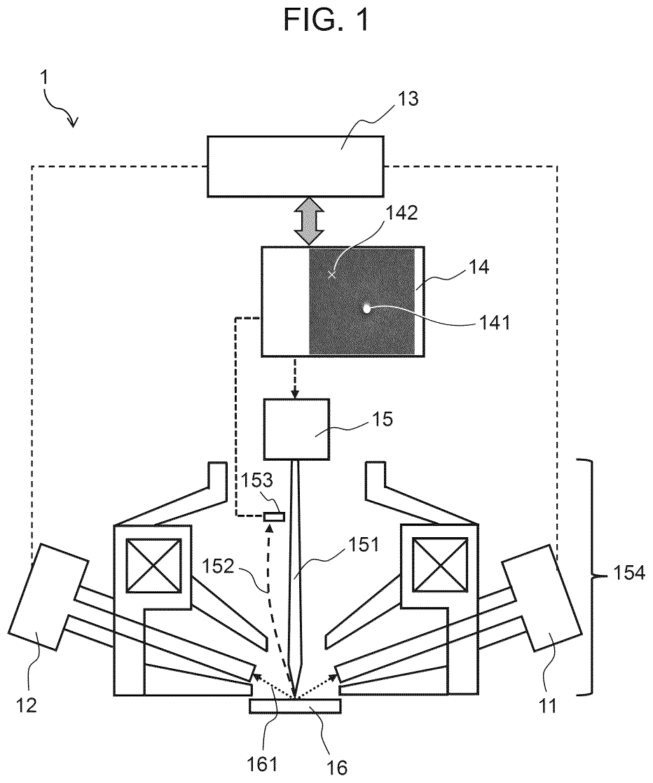

FIG. 1 is a configuration diagram of an analysis system 1 according to Embodiment 1 of the disclosure. The analysis system 1 is an apparatus that analyzes an element contained in a sample 16. The analysis system 1 schematically includes a first element analysis device 11, a second element analysis device 12, a computer system 13, an electron beam control device 14, and an electron beam generation device 15.

The first element analysis device 11 is a device that analyzes an element contained in the sample 16, and can be implemented by, for example, an EDS device. The second element analysis device 12 is a device that analyzes an element contained in the sample 16, and has higher energy resolution than the first element analysis device 11. The second element analysis device 12 can be implemented by, for example, a TES device. The electron beam generation device 15 emits an electron beam 151 to the sample 16. The electron beam control device 14 controls the electron beam generation device 15. The sample 16 is, for example, a semiconductor substrate.

### Embodiment 1: Schematic Operation of Analysis System 1

The electron beam generation device 15 condenses the electron beam 151 to a specific portion of the sample 16. Accordingly, a secondary particle 152 is generated from the sample 16. A detector 153 detects the secondary particle 152 and outputs a detection signal indicating an intensity thereof to the electron beam control device 14. The computer system 13 generates an observation image (SEM image) of the sample 16 by using the detection signal. The computer system 13 specifies, on the observation image, (a) a target portion 141 (target sample) to be subjected to elemental analysis and (b) a reference portion 142 (reference sample) for comparing the composition with the target portion 141.

Positions of the target portion 141 and the reference portion 142 may be designated by a user while viewing the observation image, or may be designated by the computer system 13 itself by searching for a specific shape pattern by an appropriate method such as template matching. For example, a position of a microparticle (for example, a foreign substance when the sample 16 is a semiconductor substrate) on the sample, a defect in a shape pattern, or the like can be specified as the target portion 141, and a position where the microparticle, the defect, and the like are not present can be specified as the reference portion 142.

The target portion 141 and the reference portion 142 may be located at different positions on the same sample, or the reference portion 142 may be designated on a reference sample different from the sample having the target portion 141. In either case, the target portion 141 is a target sample for performing elemental analysis, and the reference portion 142 is a reference sample serving as a comparison reference thereof.

The electron beam generation device 15 irradiates each of the target portion 141 and the reference portion 142 with the electron beam 151 over certain duration. The first element analysis device 11 acquires an X-ray 161 (first X-ray) emitted from the target portion 141 and the X-ray 161 (second X-ray) emitted from the reference portion 142.

The computer system 13 acquires data regarding a result obtained by the first element analysis device 11 detecting the X-ray 161, and acquires an energy spectrum (first energy spectrum) of the target portion 141 and an energy spectrum (second energy spectrum) of the reference portion 142 by using the data. The energy spectrum indicates a wavelength in energy (eV) on a horizontal axis and indicates the number (counts) of detected photons on a vertical axis.

By comparing the first energy spectrum with the second energy spectrum, the computer system 13 further determines whether to further perform the elemental analysis using the second element analysis device 12. A determination procedure will be described later in detail.

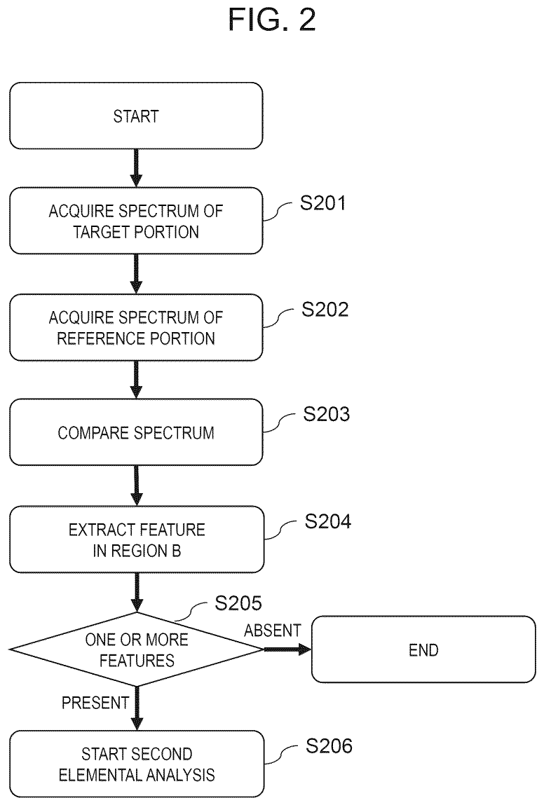

FIG. 2 is a flowchart illustrating an operation of the analysis system 1. A procedure of analyzing an element contained in the sample 16 by the analysis system 1 will be described below with reference to FIG. 2. Each step can be implemented by the computer system 13 controlling each unit of the analysis system 1.

### (FIG. 2: Steps S201 and S202)

The first element analysis device 11 detects the X-ray 161 from each of the target portion 141 and the reference portion 142. The computer system 13 acquires the energy spectrum of the target portion 141 (S201: first energy spectrum) and the energy spectrum of the reference portion 142 (S202: second energy spectrum).

### (FIG. 2: Steps S203 and S204)

The computer system 13 compares the first energy spectrum with the second energy spectrum (S203), and extracts a feature from a region B on the energy spectrum (S204). An example of the region B will be described later.

### (FIG. 2: Steps S205 and S206)

When one or more features are extracted in the region B (S205: PRESENT), the computer system 13 further uses the second element analysis device 12 to analyze the element in the target portion 141 (S206). When no feature is extracted (S205: ABSENT), the processing of this flowchart ends without using the second element analysis device 12.

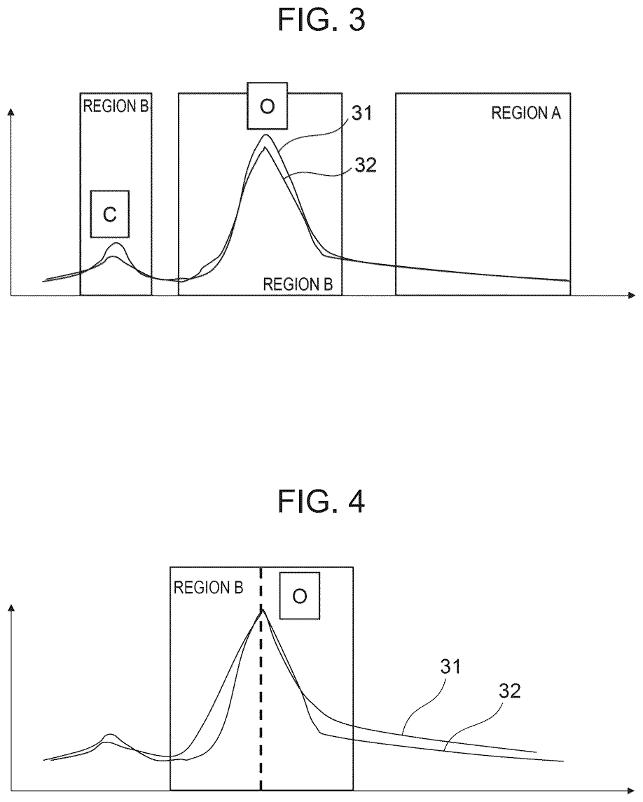

FIG. 3 illustrates an example of a first energy spectrum 31 and a second energy spectrum 32 in S203. FIG. 3 illustrates an example of an energy spectrum, from which features corresponding to carbon (C) and oxygen (O) are extracted, on energy spectrums acquired by the first element analysis device 11.

The computer system 13 can set, for example, a peripheral region of a characteristic X-ray of an assumed element species as the region B. In this example, with characteristic X-rays of carbon and oxygen (C-Kα line: 273 eV, O-Kα line: 525 eV) as a reference, an energy range of +40 eV of the reference is set as the region B.

Instead, the computer system 13 may set an energy range, in which a significant difference occurs between the first energy spectrum 31 and the second energy spectrum 32, as the region B. In the example illustrated in FIG. 3, there is a significant difference between the spectrums in energy ranges before and after the characteristic X-rays of of carbon and oxygen. Therefore, the computer system sets the energy range similar to that described above as the region B. The difference between energy spectrums can be calculated, for example, by adding the square of the difference of count values between spectrums for each energy value.

### Embodiment 1: Matching Processing Between Spectrums

A case of using a difference between spectrums as an example of the feature in S204 and S205 is assumed. When the difference is equal to or greater than a threshold, the difference can be used as the feature of the energy spectrum of the target portion 141. However, in order to appropriately extract the difference, in an energy region where there is no difference in element composition between the target portion 141 and the reference portion 142, it is necessary that spectrum values (count values of the vertical axis) coincide with each other (the spectrum values may not be necessarily in strict coincidence, but are necessarily in coincidence such that at least the difference between the spectrums is less than a reference value). Accordingly, the computer system 13 adjusts one of the energy spectrums according to the following procedure such that the difference between the spectrums in a region (a region A in FIG. 3) other than the region B is less than the reference value.

The computer system 13 desirably sets, as the region A, an energy region (that is, an energy region other than the region B) from which the feature is not extracted, and adjusts one of the energy spectrums such that the difference between the energy spectrums in the region A is less than the reference value. Specifically, a scale of the count value (spectrum value) in each energy is adjusted by multiplying the count value by an appropriate coefficient so that the difference in the region A is less than the reference value. Accordingly, in the energy region (region A) in which there is no difference in element composition between the target portion 141 and the reference portion 142, the energy spectrums coincide with each other. That is, a difference in element composition is clearly indicated as a feature in the region B. Such processing of adjusting the difference between the energy spectrums in the region A to be less than the reference value is called matching processing between spectrums.

When the target portion 141 is small, it is desirable to lower an acceleration voltage of the electron beam 151. On the other hand, in order to generate a target characteristic X-ray, energy of the electron beam 151 needs to be higher than energy of the characteristic X-ray. For example, when a transition metal is assumed as an element of the target portion 141, energy of a characteristic X-ray of the transition metal is 1.5 keV or less, and an acceleration voltage of the electron beam 151 may be 2.5 kV to 3 kV in consideration of generation efficiency of the X-ray. In this case, the generation efficiency of a characteristic X-ray of 2 keV or more is low, and an intensity of a continuous X-ray is dominant over an intensity of the characteristic X-ray. That is, a possibility that an energy region of 2 keV or more is set as the region B is low. Therefore, when a transition metal is assumed as the target portion 141, an energy region of 2 keV or more is suitable for the region A.

FIG. 4 is a diagram illustrating another example of the matching processing between energy spectrums. Here, a case where the sample 16 is a silicon substrate is assumed. In this case, a Si-Kα line is normally obtained as an X-ray from the silicon substrate. Further, an O-Kα line is normally obtained as an X-ray from oxygen attached to a surface of the substrate. Therefore, in this example, an energy region corresponding to Si-Kα and O-Kα of the energy spectrums is essentially set as the region B.

When a spectrum peak of O-Kα is shifted between the target portion 141 and the reference portion 142, a difference between the target portion 141 and the reference portion 142 in a spectrum tail region of the O-Kα line is reduced, and there is a possibility that a weak characteristic X-ray obscure in the tail region may be undetected. The same situation occurs in Si-Kα. Such a shift of the spectrum peak is caused by absorption of the Si-Kα line and the O-Kα line of the substrate by the target portion 141.

Therefore, the computer system 13 acquires the difference between the energy spectrum of the target portion 141 and the energy spectrum of the reference portion 142 after matching respective spectrum peaks of O-Kα and Si-Kα. Accordingly, it is possible to more reliably extract the difference between the energy spectrums in the tail region. Specifically, the computer system 13 adjusts one of the energy spectrums such that the difference between the spectrum peaks of O-Kα and Si-Kα is less than the reference value. That is, the scale of the count value is adjusted by multiplying the count value of each energy by an appropriate coefficient so that the difference between the spectrum peaks in the region B is less than the reference value. FIG. 4 shows the results. Such processing of matching spectrum peaks is also an example of the matching processing between spectrums.

After matching the spectrum peaks, the computer system 13 compares the spectrums 31 and 32 in an energy range excluding the peaks. In FIG. 4, the difference between the spectrums appears remarkably in a skirt portion of the region B. The computer system 13 can extract a feature (the difference between the spectrums in this example) based on the comparison result.

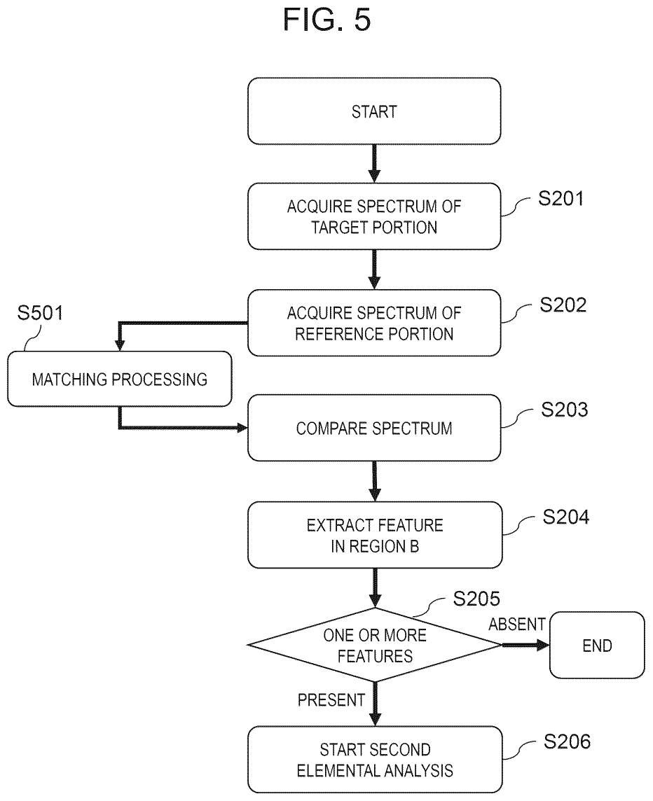

FIG. 5 is a flowchart illustrating an operation of the analysis system 1 in a case of matching energy spectrums between the target portion 141 and the reference portion 142. This flowchart is obtained by adding S501 between S202 and S203 to the flowchart illustrated in FIG. 2. In S501, the computer system performs matching between energy spectrums described with reference to FIGS. 3 and 4. The matching processing may be used in combination.

### Embodiment 2

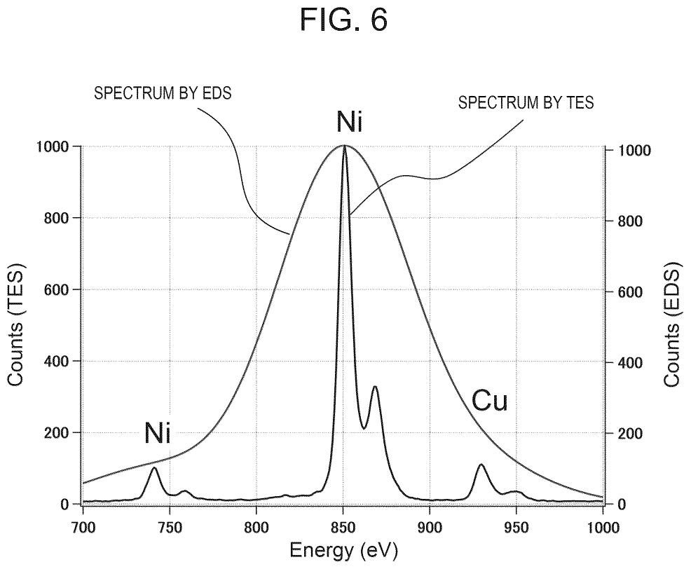

FIG. 6 illustrates an example in which an energy spectrum acquired using the EDS and an energy spectrum acquired using the TES are reflected together. In this example, a weak Cu-Lα line (930 eV) exists in the vicinity of a Ni-Lα line (853 eV) and a Ni-Lβ line (868 eV), which are transition metals.

Transition metal information may be important information for the user, and the user does not want to miss even traces of X-ray peak information of the transition metal. However, in a case where a minute sub-peak exists in the vicinity of a main peak as illustrated in FIG. 6, there is a high possibility that such a weak sub-peak is missed when only the first element analysis device 11 (EDS) is used. In Embodiment 2 of the present disclosure, a procedure of detecting such a sub-peak will be described. The configuration of the analysis system 1 is the same as that of Embodiment 1.

As an example in which a minute sub-peak is obscure as illustrated in FIG. 6, there is a case where a peak of an energy spectrum of a transition metal is large. In FIG. 6, an Ni spectrum of 853 eV corresponds to the case. Therefore, in the embodiment, when there is a feature (for example, a peak corresponding to Ni) of a transition metal in the energy spectrum of the target portion 141 (or the reference portion 142), the second element analysis device 12 is used to detect a sub-peak that may be obscure. The obscure sub-peak may be a transition metal or an element other than a transition metal. FIG. 6 illustrates an example in which both the large peak and the sub-peak are transition metals.

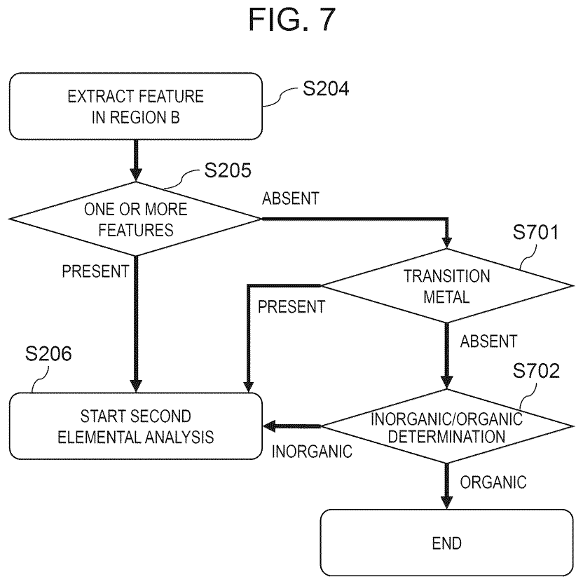

FIG. 7 is a flowchart illustrating an operation of the analysis system 1 according to Embodiment 2. This flowchart is obtained by adding steps S701 and S702 after S205 (S205: absent) in addition to the flowchart illustrated in FIG. 2. For convenience of illustration, the steps before S204 are omitted.

### (FIG. 7: Step S701)

If one or more features are not extracted in S205, the computer system 13 further determines whether a feature of a transition metal is included in the first energy spectrum. The energy range for determining the presence or absence of the transition metal may be the region B or may be a region other than the region B. When the transition metal is contained, the processing proceeds to S206, and the transition metal is analyzed in detail using the second element analysis device 12. If no transition metal is contained, the processing proceeds to S701. Whether a transition metal is contained can be determined based on whether a spectrum peak corresponding to the transition metal (peak of Ni of 853 eV in FIG. 6) is present.

### (FIG. 7: Step S702)

The computer system 13 determines whether the target portion 141 is an inorganic substance or an organic substance. In the embodiment, it is assumed that the user is interested in an inorganic substance, and thus the processing of the flowchart is ended when the target portion 141 is an organic substance. In case of an inorganic substance, the processing proceeds to S206, and the inorganic substance is analyzed in detail using the second element analysis device 12. The procedure of determining whether the target portion is an inorganic substance or an organic substance will be described below.

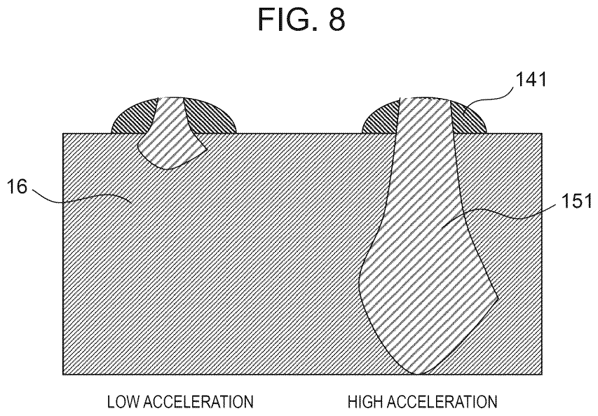

FIG. 8 is a side sectional view schematically illustrating an acceleration voltage of the electron beam 151 and the spread of the electron beam 151 in the sample 16. As the acceleration voltage of the electron beam 151 increases and a size of the target portion 141 decreases, a probability that the electron beam 151 passes through the target portion 141 increases, and the amount of the X-ray 161 from the target portion 141 decreases. On the other hand, there is a correlation between ionization cross section area, which is an index of the X-ray generation efficiency, and an over-voltage ratio, and when the over-voltage ratio is about 3, the ionization cross section area is the largest. Since the characteristic X-ray energy of carbon, which is a main component of the organic substance, is 273 eV, the acceleration voltage of the electron beam 151 is preferably about 1 kV in order to maximize the ionization cross section area.

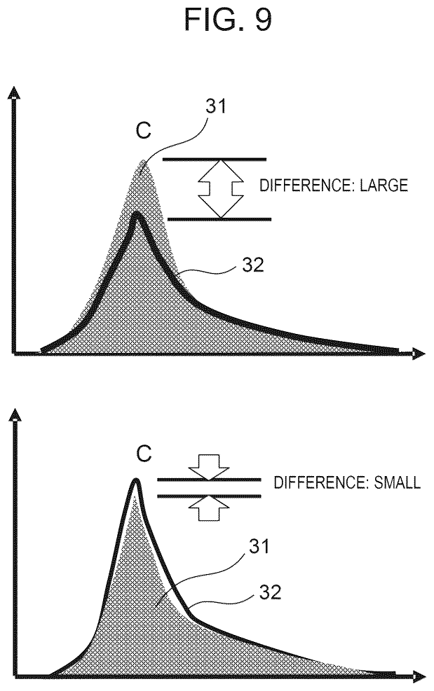

FIG. 9 is a diagram illustrating an energy spectrum in a case where the target portion 141 is an organic substance and an energy spectrum in a case where the target portion 141 is an inorganic substance. An upper portion of FIG. 9 shows an image of a spectrum in the vicinity of the C-Kα line in the case where the target portion 141 is an organic substance and the reference portion 142 is silicon. When the target portion 141 is carbon, a peak intensity of C-Kα is higher than that of the reference portion 142. A lower portion of FIG. 9 shows an image of a spectrum in the vicinity of the C-Kα line in the case where the target portion 141 is an inorganic substance and the reference portion 142 is silicon. When the electron beam 151 is irradiated to the target portion 141 and the sample 16 (silicon), although depending on a degree of vacuum of a vacuum chamber accommodating an optical system unit 154, a carbon film is always formed on the surface thereof (carbon contamination). Accordingly, even when the target portion 141 is an inorganic substance, a carbon spectrum similar to that of the silicon substrate is obtained from the target portion 141. Therefore, in this case, a difference in C-Kα line peak between the target portion 141 and the reference portion 142 is small.

Thus, a difference in spectrum peak of the C-Kα line between the target portion 141 and the reference portion 142 is large when the target portion 141 is an organic substance, and is small when the target portion 141 is an inorganic substance. The computer system 13 can determine whether the target portion 141 is an organic substance or an inorganic substance based on the difference in S702. Specifically, it can be determined that the target portion 141 is an organic substance when the difference in spectrum peak in the vicinity of the C-Kα line between the target portion 141 and the reference portion 142 is equal to or greater than a threshold, and is an inorganic substance when the difference is smaller than the threshold.

The most significant difference in spectrum peak is presented when the acceleration voltage of the electron beam 151 is about (or equal to or less than) 1 kV as described with reference to FIG. 8. Therefore, after S205 and before starting S702, the computer system 13 changes the acceleration voltage of the electron beam 151 to 1 kV or less. Accordingly, even when no feature is detected in S205, the difference in spectrum peak described in FIG. 9 can be significantly identified.

The determination of the organic substance and the inorganic substance is not necessarily performed using the difference in spectrum peak, and a feature equivalent to the difference may be used. For example, it is conceivable to compare spectrum area in the vicinity of the peak between the spectrums 31 and 32. In addition, similar features may be used.

### Embodiment 3

In Embodiment 2, it is described that when there is no difference between the target portion 141 and the reference portion 142 (that is, when there is no feature of the energy spectrum, S205: absent), the processing proceeds to S701 to analyze the transition metal. Alternatively, when a transition metal is obtained at the time of acquiring the X-ray spectrum of the target portion 141, analysis using the second element analysis device 12 may be started. In embodiment 3 of the present disclosure, a specific example thereof will be described. The configuration of the analysis system 1 is the same as that of Embodiment 1.

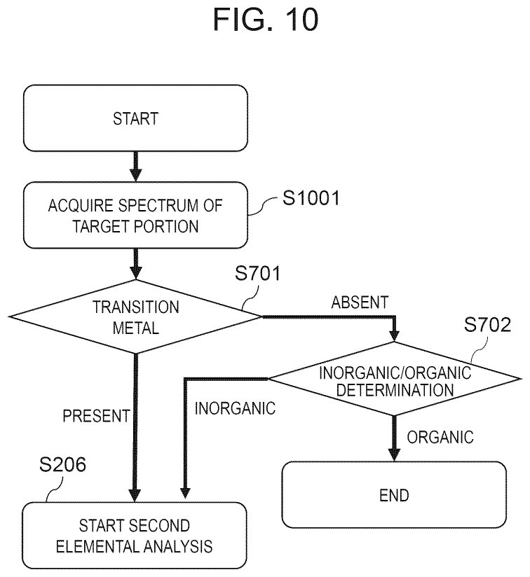

FIG. 10 is a flowchart illustrating an operation of the analysis system 1 according to Embodiment 3. In step S1001, the computer system 13 acquires an energy spectrum of the target portion 141 by using the first element analysis device 11. Subsequent operations are the same as those of S701 and following steps in FIG. 7. That is, in a case where a transition metal is detected when the energy spectrum is acquired by the first element analysis device 11, analysis using the second element analysis device is started without acquiring the spectrum of the reference portion 142 (S206). This is effective when the analysis using the first element analysis device 11 is shifted to the analysis using the second element analysis device 12 in a short time.

However, as described with reference to FIG. 9, the acceleration voltage of the electron beam 151 may be switched when determining the inorganic substance/organic substance. In a case where the acceleration voltage is switched again when the processing proceeds from S702 to S206, a certain time is required for the switching. Therefore, when the feature of the transition metal is not included in the energy spectrum in S701, the processing of the flowchart may be ended without performing either S702 or S206. Accordingly, the analysis of the transition metal is prioritized, and the reduction of the measurement time is prioritized.

The computer system 13 may switch between performing and not performing the flowchart of FIG. 10 according to, for example, designation of the user. That is, processing in FIG. 10 is implemented in a case where the user desires to shift from the analysis using the first element analysis device 11 to the analysis using the second element analysis device 12 in a short time, and the processing of the flowchart described in Embodiments 1 and 2 may be performed in other cases.

### Embodiment 4

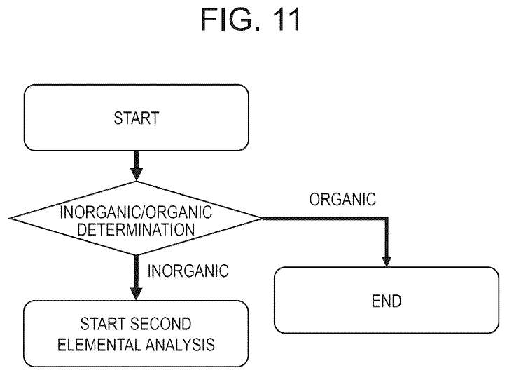

FIG. 11 is a flowchart illustrating an operation of the analysis system 1 according to Embodiment 4 of the disclosure. The inorganic/organic determination described with reference to FIG. 9 may be performed alone. In this case, the computer system 13 sets the acceleration voltage to 1 kV or less, and then executes the procedure described with reference to FIG. 9. If the target portion 141 is an inorganic substance, further analysis is performed using the second element analysis device 12. This flowchart shows the above procedure.

The computer system 13 may switch between performing and not performing the flowchart of FIG. 11 according to, for example, designation of the user. For example, in a case where the position of the target portion 141 is specified in advance and it is desired to know whether an inorganic substance exists at that position, the processing in FIG. 11 may be performed. In other cases, the processing in flowcharts described in Embodiments 1 to 3 can be executed.

### Embodiment 5

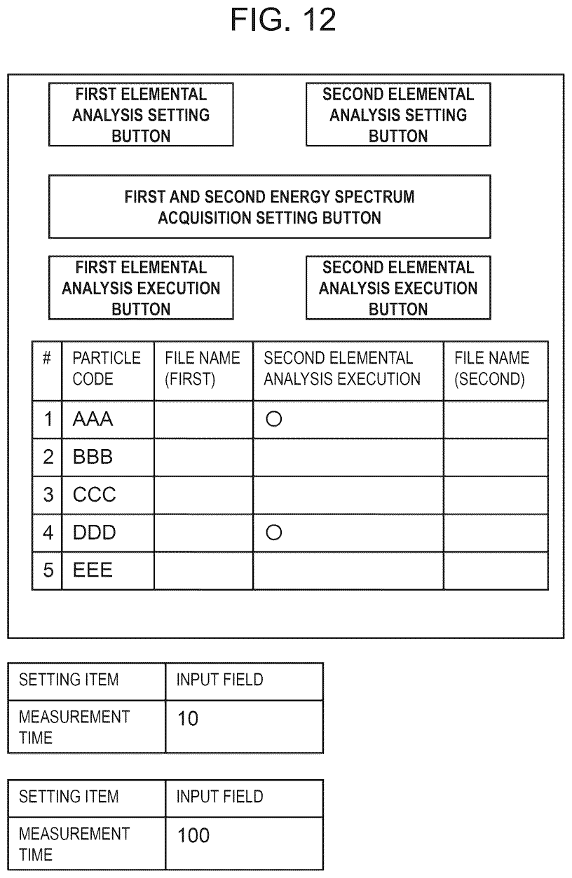

FIG. 12 illustrates an example of a user interface provided by the computer system 13. In the above-described embodiments, the computer system 13 may receive an operation instruction from the user by displaying a user interface (GUI) as illustrated in FIG. 12 on a screen.

A first elemental analysis setting button and a second elemental analysis setting button are provided on the GUI. When each button is pressed, corresponding pop up screens (lower portion of FIG. 12) for inputting a time are displayed, and the user inputs a measurement time of using the first element analysis device 11 and a measurement time of using the second element analysis device 12 on the screen. Any necessary setting item other than the time setting may be added.

The GUI further includes a field in which position information and particle (defect) code information output from an inspection device, which is different from the analysis system 1 and specifies a particle position, are described. In this field, for example, a file name describing a first elemental analysis result and a file name describing a second elemental analysis result (spectrum, element information, and the like) are described. Further, a “second elemental analysis execution” field is provided so as to be able to identify the sample 16 that is shifted to the analysis using the second element analysis device 12 among samples 16 analyzed using the first element analysis device 11, and “o” is assigned for the shifted sample 16.

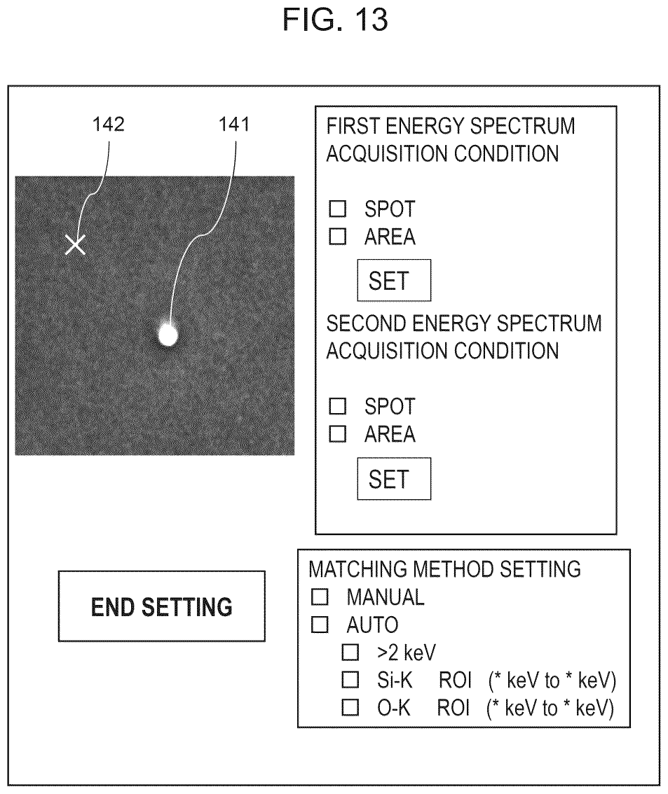

When a first and second energy spectrum acquisition setting button is pressed, the computer system 13 displays the user interface described with reference to FIG. 13 on the screen.

FIG. 13 illustrates another example of the user interface provided by the computer system 13. The GUI displays an observation image (SEM image) of the sample 16. The SEM image includes the target portion 141 and the reference portion 142.

The GUI further includes a field for setting conditions of first energy spectrum acquisition and second energy spectrum acquisition. The user selects spot analysis or area analysis in the first energy spectrum acquisition and the second energy spectrum acquisition.

The GUI further includes a field for selecting a matching method between energy spectrums. The matching method can be selected from, for example, (a) a manual method in which a user selects a range, (b) 2 keV or more (the procedure described in FIG. 3), (c) a method using a peak of the S-Kα line or O-Kα line (the procedure described in FIG. 4). When the Si-Kα line and the O-Kα line are used, an energy range (region of interest (ROI)) for comparing the first energy spectrum and the second energy spectrum is set. When a setting end button is pressed, the screen returns to the screen in FIG. 12.

When the user presses a first elemental analysis execution button on the screen in FIG. 12, the operation of each flowchart is performed. For the sample with “o” in the second elemental analysis field, the analysis using the second element analysis device 12 may be automatically started, or may be started when a second elemental analysis execution button is pressed.

The GUI may display each energy spectrum. For example, the energy spectrum of the target portion 141, the energy spectrum of the reference portion 142, and the like can be displayed. The result of performing the matching processing and the process of the matching processing may be displayed.

### <Regarding Modification of Present Disclosure>

The present disclosure is not limited to the embodiments described above, and includes various modifications. For example, the embodiments described above are described in detail to facilitate understanding of the present disclosure, and it is not necessary to include all of the configurations described. A part of one embodiment can be replaced with a configuration of another embodiment. A configuration of another embodiment can be added to a configuration of one embodiment. A part of a configuration of each embodiment may be deleted, added with a part of a configuration of another embodiment, or replaced with a part of a configuration of another embodiment.

Although it is described in Embodiment 2 that the acceleration voltage of the electron beam 151 is preferably about 1 kV, which is an example, other acceleration voltages may be used. The sub-peak of the transition metal shown in FIG. 6 is an example, and the L line of the transition metal may be obscure in a skirt region of the K line of another light element. Even in such a case, an obscure transition metal can be detected by the procedure of Embodiment 2.

In the embodiments described above, the position where the energy spectrum of the X-ray is acquired is specified by using the observation image of the sample 16 formed using the electron beam 151. In a case where the sample 16 is a semiconductor wafer as an example, the position of microparticles adhering to the sample surface (or the position of a defect in shape pattern) is specified based on the observation image and an element of the microparticles is specified by each element analysis device, whereby a failure cause and the like can be analyzed.

In the embodiments described above, the computer system 13 can be implemented by an arithmetic device such as a processor that executes a program in which the procedure of each flowchart is implemented, and a storage device that stores the program. Alternatively, the computer system 13 may be implemented by hardware such as a circuit device in which the same procedure is implemented, instead of the program.

### REFERENCE SIGNS LIST

1: ANALYSIS SYSTEM
11: FIRST ELEMENT ANALYSIS DEVICE
12: SECOND ELEMENT ANALYSIS DEVICE
13: COMPUTER SYSTEM
141: TARGET PORTION
142: REFERENCE PORTION
16: SAMPLE

1. An analysis system for analyzing an element contained in a sample, the analysis system comprising:
a computer system configured to analyze an element contained in the sample by using a result obtained by detecting an X-ray generated from the sample, wherein
the computer system acquires a first energy spectrum of a first X-ray generated from a target sample by using a first element analysis device,
the computer system acquires a second energy spectrum of a second X-ray generated from a reference sample by using the first element analysis device, and
the computer system analyzes an element contained in the target sample by using a second element analysis device having higher energy resolution than the first element analysis device based on a result obtained by comparing the first energy spectrum with the second energy spectrum.

2. The analysis system according to claim 1, wherein
the computer system determines whether one or more features are present in a first energy range on the first energy spectrum or the second energy spectrum by comparing the first energy spectrum with the second energy spectrum, and
the computer system analyzes an element contained in the target sample by using the second element analysis device when the feature is present, and does not perform analysis using the second element analysis when no feature is present.

3. The analysis system according to claim 2, wherein
the computer system performs first matching processing of multiplying a spectrum value of at least one of the first energy spectrum or the second energy spectrum by a coefficient so that a difference between the first energy spectrum and the second energy spectrum is less than a threshold in a second energy range different from the first energy range, and
the computer system determines whether the feature is present by comparing, in the first energy range, the first energy spectrum and the second energy spectrum subjected to the first matching processing.

4. The analysis system according to claim 3, wherein
the first element analysis device is a device configured to generate an X-ray from the target sample and the reference sample by irradiating each of the target sample and the reference sample with an electron beam, and
the second energy range is a range in which energy of the electron beam is 2 keV or more.

5. The analysis system according to claim 2, wherein
the computer system performs second matching processing of multiplying a spectrum value of at least one of the first energy spectrum or the second energy spectrum by a coefficient so that a difference between a first peak of the first energy spectrum and a second peak of the second energy spectrum is less than a threshold in the first energy range, and
the computer system determines whether the feature is present by comparing, in an energy range that does not coincide with either the first peak or the second peak, the first energy spectrum and the second energy spectrum subjected to the second matching processing.

6. The analysis system according to claim 5, wherein
the target sample and the reference sample are a silicon substrate, and
the first peak and the second peak are a spectrum peak of at least one of a Kα line of oxygen or a Kα line of silicon.

7. The analysis system according to claim 2, wherein
when the feature is not detected in the first energy range and the feature of a transition metal is detected in a third energy range, the computer system analyzes an element of the transition metal by using the second element analysis device.

8. The analysis system according to claim 2, wherein
when the feature is not detected in the first energy range, the feature of a transition metal is not detected in a third energy range, and the feature not indicating a transition metal is detected in the third energy range, the computer system determines whether the feature is a feature of an organic substance.

9. The analysis system according to claim 8, wherein
the computer system detects, as the feature in the third energy range, a difference between the first energy spectrum and the second energy spectrum in the third energy range, and
the computer system determines that the difference is a feature of an organic substance when the difference is equal to or greater than a threshold, and determines that the difference is a feature of an inorganic substance when the difference is less than the threshold.

10. The analysis system according to claim 8, further comprising:
an irradiation unit configured to irradiate each of the target sample and the reference sample with an electron beam, wherein
the computer system compares the first energy spectrum with the second energy spectrum, which are obtained by emitting the electron beam at an acceleration voltage of 1 kV or less, to determine whether a feature in the third energy range is a feature of an organic substance.

11. The analysis system according to claim 1, wherein
after the first energy spectrum is acquired and before the second energy spectrum is acquired, the computer system determines whether a feature of a transition metal is present in the first energy spectrum, and
when a feature of a transition metal is present in the first energy spectrum, the computer system analyzes an element contained in the target sample by using the second element analysis device without acquiring the second energy spectrum.

12. The analysis system according to claim 11, wherein
when a feature of a transition metal is not present in the first energy spectrum, the computer system further determines whether a feature of an organic substance or an inorganic substance is present, and
when a feature of an inorganic substance is detected in the first energy spectrum, the computer system analyzes an element contained in the target sample by using the second element analysis device.

13. The analysis system according to claim 1, wherein
the computer system provides a user interface that presents at least any one of
the first energy spectrum,
the second energy spectrum, and
an observation image of the sample.

14. The analysis system according to claim 1, wherein
the first element analysis device is an energy dispersive X-ray spectroscopy device, and
the second element analysis device is an X-ray analysis device using a superconducting transition edge sensor.

15. An analysis method for analyzing an element contained in a sample, the analysis method comprising:
a step of analyzing an element contained in the sample by using a result obtained by detecting an X-ray generated from the sample, wherein
in the analysis step, a first energy spectrum of a first X-ray generated from a target sample is acquired by using a first element analysis device,
in the analysis step, a second energy spectrum of a second X-ray generated from a reference sample is acquired by using the first element analysis device, and
in the analysis step, an element contained in the target sample is analyzed by using a second element analysis device having higher energy resolution than the first element analysis device based on a result obtained by comparing the first energy spectrum with the second energy spectrum.

16. An analysis program for causing a computer to execute processing of analyzing an element contained in a sample, the analysis program causing the computer to execute:
a step of analyzing an element contained in the sample by using a result obtained by detecting an X-ray generated from the sample, wherein
in the analysis step, the computer is caused to execute a step of acquiring a first energy spectrum of a first X-ray generated from a target sample by using a first element analysis device,
in the analysis step, the computer is caused to execute a step of acquiring a second energy spectrum of a second X-ray generated from a reference sample by using the first element analysis device, and
in the analysis step, the computer is caused to execute a step of analyzing an element contained in the target sample by using a second element analysis device having higher energy resolution than the first element analysis device based on a result obtained by comparing the first energy spectrum with the second energy spectrum.
